(19) United States
(12) Patent Application Publication
(10) Pub. No.: US 2026/0178962 A1
(43) Pub. Date: Jun. 25, 2026

(54) PREDICTION SYSTEM, CONTROL DEVICE, AND CONTROL METHOD

(71) Applicant: HITACHI, LTD., Tokyo (JP)

(72) Inventors: Yoshiyuki Tajima, Tokyo (JP); Yoshinori Mochizuki, Tokyo (JP)

(73) Assignee: HITACHI, LTD., Tokyo (JP)

(21) Appl. No.: 18/859,308

(22) PCT Filed: Feb. 28, 2023
(86) PCT No.: PCT/JP2023/007255

§ 371 Date: Oct. 23, 2024

(30) Foreign Application Priority Data
May 24, 2022 (JP) 2022-084824

(51) Int. Cl. G06N 20/00

(52) U.S. Cl. CPC G06N 20/00

(57) ABSTRACT

A prediction system including a storage device and a processor, which executes the software program to manage a second prediction model for predicting an output value from an input value and a first prediction model for calculating parameters of the second prediction model based on the input value, to predict the output value for the input value by using the second prediction model to which the parameters calculated by the first prediction model are applied, and to use one or more pieces of training data in the neighborhood of a certain piece of training data included in training data used to generate the first prediction model and the second prediction model as neighborhood data and update parameters of the first prediction model to minimize errors occurring in values of output variables calculated by the first and the second prediction model from values of input variables of the neighborhood data.

### TECHNICAL FIELD

The present disclosure relates to technology for predicting a prediction target using a learned prediction model.

### BACKGROUND ART

There has been a demand for automation using robots in various sites, such as production lines and logistics sites, and efforts are being made to achieve such demand. In complex sites where a plurality of robots exist together, there is a possibility of physical interference between the robots, such as collisions between robot arms, and thus complex control for performing appropriate coordination between the plurality of robots is required. Since it is difficult to design all of the complex controls in advance, a data science approach is essential. However, in the data science approach, when a model with a large degree of freedom is used, a certain degree of prediction accuracy may not be obtained in unknown or extrapolated regions. In response to such problem, there is a method that uses a local regression model to improve prediction accuracy in unknown or extrapolated regions.

PTL 1 discloses a state prediction device that predicts the state of a product using a local regression model. The state prediction device disclosed in PTL 1 extracts actual result data having a manufacturing condition similar to a manufacturing condition for a prediction target as neighborhood teaching data, generates a local weighted regression model for predicting a prediction target item using the neighborhood teaching data, and calculates a predicted value of an error using the local weighted regression model. Here, when a certain manufacturing condition for a prediction target is in an extrapolated state indicating being outside the range of the neighborhood teaching data, the state prediction device excludes the manufacturing condition from the neighborhood teaching data and then performs regression calculation.

### CITATION LIST

### Patent Literature

PTL 1: JP2018-10521A

### SUMMARY OF INVENTION

### Technical Problem

In the technology disclosed in PTL 1, when a certain point is predicted, a neighborhood of the point to be predicted is determined, actual result data of the neighborhood is extracted as neighborhood teaching data, a local weighted regression model is generated from the neighborhood teaching data, and prediction is performed using the regression model. That is, it is necessary to determine neighborhood, extract neighborhood teaching data, and generate regression model each time prediction is performed, which is troublesome processing. Further, in the technique disclosed in PTL 1, a method of determining neighborhood is also troublesome. Complicated processing increases the amount of calculation, which may result in a delay in control.

An object of the disclosure is to provide technology that makes it possible to obtain sufficient prediction accuracy while reducing the complexity of processing each time prediction is performed.

### Solution to Problem

A prediction system according to one aspect included in the disclosure is a prediction system that predicts an output value, which is a value of an output variable, from an input value, which is a value of an input variable to be predicted, the prediction system including a storage device that stores a software program, and a processor that executes the software program, in which the processor executes the software program to realize a model management unit that manages a second prediction model for predicting the output value from the input value and a first prediction model for calculating parameters of the second prediction model based on the input value, and a prediction execution unit that predicts the output value for the input value by using the second prediction model to which the parameters calculated by the first prediction model are applied, and the model management unit uses one or more pieces of training data in the neighborhood of a certain piece of training data included in training data used to generate the first prediction model and the second prediction model as neighborhood data, and updates parameters of the first prediction model to minimize errors occurring in values of output variables calculated by the first prediction model and the second prediction model from values of input variables of the neighborhood data.

### Advantageous Effects of Invention

According to an aspect of the disclosure, it is possible to obtain sufficient prediction accuracy while reducing the complexity of processing each time prediction is performed.

### BRIEF DESCRIPTION OF DRAWINGS

FIG. 1 is a block diagram showing a control system according to a first embodiment.

FIG. 2 is a block diagram showing a hardware configuration of a control device.

FIG. 3 is a flowchart of the overall processing executed by a prediction system.

FIG. 4 is a conceptual diagram showing prediction models generated by a model management unit.

FIG. 5 is a flowchart of prediction processing in the first embodiment.

FIG. 6 is a conceptual diagram showing a state where two input variables for a second prediction model are selected.

FIG. 7 is a diagram showing a state where a response surface is displayed.

FIG. 8 is a conceptual diagram showing an on-site system according to a first example.

FIG. 9 is a block diagram of a control system according to a second example.

FIG. 10 is a simplified conceptual diagram of a cold rolling device.

FIG. 11 is a block diagram of a control system according to a third example.

FIG. 12 is a simplified block diagram of an automatic physical property searching robot.

FIG. 13 is a flowchart of prediction processing in a second embodiment.

FIG. 14 is a conceptual diagram showing a prediction model generated by a model management unit in a modification example.

### DESCRIPTION OF EMBODIMENTS

Hereinafter, embodiments of the present invention will be described with reference to the drawings.

### First Embodiment

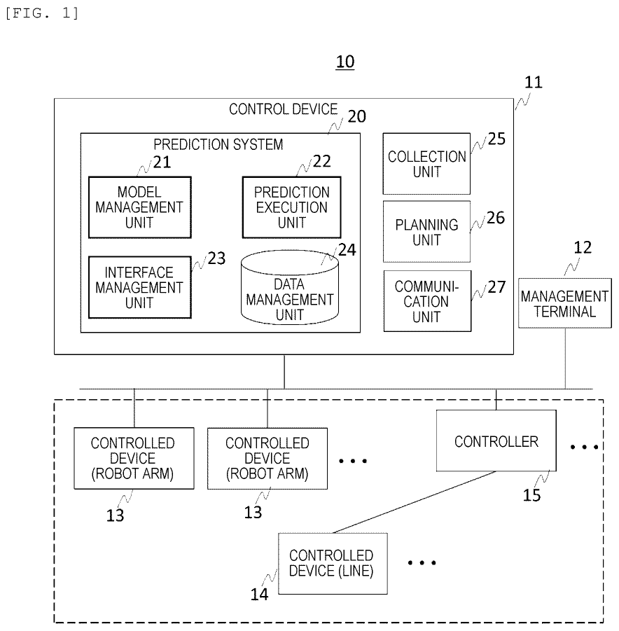

FIG. 1 is a block diagram showing a control system according to a first embodiment.

A control system 10 includes a control device 11, a management terminal 12, controlled devices 13 and 14, and a controller 15.

The control device 11 is a device that performs calculation for controlling the controlled devices 13 and 14 on the site.

The management terminal 12 is a terminal device that provides a user interface for performing screen display, information input, and operation for the control device 11. For example, an administrator can create training data based on actual result data and confirm results of visualization processing in the control device 11 on the screen.

The controlled device 13 is a device that operates based on a control command received from the control device 11. As an example, the controlled device 13 is a robot arm device which is a work device including a controller performing inverse kinematic calculation and simple trajectory planning and performing work on articles on a line. The controlled device 13 can move an arm to a coordinate position designated by the control device 11.

The controlled device 14 is a device that operates based on a command signal from the controller 15 that received the control command from the control device 11. As an example, the controlled device 14 is a line conveyance device that conveys articles on a line.

The controller 15 is a device that outputs a command signal to the controlled device 14 based on the control command received from the control device 11.

The control device 11 includes a prediction system 20, a collection unit 25, a planning unit 26, and a communication unit 27.

The prediction system 20 is a system that learns training data to generate a prediction model, imparts input values of input variables to be predicted to the prediction model, and calculates output values of output variables which are prediction results.

The collection unit 25 is a device that collects data from the controlled devices 13 and 14. The collection unit 25 collects actual result data from the controlled devices 13 and 14, creates training data based on the actual result data, and imparts the training data to the prediction system 20.

The planning unit 26 is a device that generates control commands for the controlled devices 13 and 14 based on the prediction results of the prediction system 20 and applies the control commands to the controlled devices 13 and 14. The control commands are directly applied to the controlled device 13 and are applied to the controlled device 14 via the controller 15. For example, the planning unit 26 generates best control commands by repeatedly using prediction calculation of the prediction system 20 a plurality of times to realize control according to a predetermined plan, and transmits the generated control commands to the controlled device 13 and/or the controller 15.

The communication unit 27 is a device that performs data communication with the management terminal 12, the controlled device 13, and the controller 15.

The prediction system 20 includes a model management unit 21, a prediction execution unit 22, an interface management unit 23, and a data management unit 24.

The model management unit 21 learns the training data imparted by the collection unit 25 to generate a prediction model, and the prediction execution unit 22 applies the values of the input variables imparted by the planning unit 26 to the prediction model to calculate the values of the output variables by using the prediction model and returns the values of the output variables to the planning unit 26. The model management unit 21 updates the prediction model based on the training data. Details of the processing performed by the model management unit 21 and the prediction execution unit 22 will be described later.

The interface management unit 23 receives connections from the management terminal 12 and provides various user interfaces to the administrator operating the management terminal 12. The administrator operating the management terminal 12 can create training data, register various parameters, confirm metrics of learning results on the screen, and confirm a response surface on the screen from the user interface provided by the interface management unit 23.

The data management unit 24 records and manages various types of data such as actual result data obtained by control execution, training data created based on the actual result data, prediction models, and the parameters thereof.

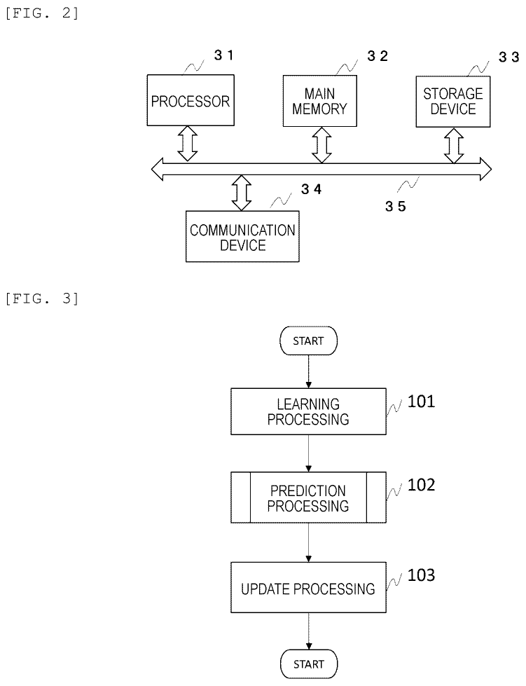

FIG. 2 is a block diagram showing a hardware configuration of the control device.

The control device 11, which is a computer connected to a communication network, includes a processor 31, a main memory 32, a storage device 33, and a communication device 34 as hardware, which are connected to a bus 35.

The storage device 33 stores data to be writable and readable, and stores various types of data of the data management unit 24 shown in FIG. 1. The processor 31 is a processor that reads the data stored in the storage device 33 into the main memory 32 and executes processing of a software program by using the main memory 32. The processor 31 executes the software program to realize the model management unit 21, the prediction execution unit 22, the interface management unit 23, the collection unit 25, and the planning unit 26 shown in FIG. 1. The communication device 34 transmits information processed by the processor 31 via a communication network and provides the information received via the communication network for the processing of the processor 31. The received information is used for software processing in the processor 31.

FIG. 3 is a flowchart of the overall process executed by the prediction system.

In step 101, the model management unit 21 executes learning processing. The learning processing is processing for learning training data to generate a prediction model.

FIG. 4 is a conceptual diagram showing prediction models generated by the model management unit. As shown in FIG. 4, the model management unit 21 generates a first prediction model and a second prediction model.

The first prediction model is a prediction model for calculating a parameter Og of the second prediction model based on the value of an input variable (input value) x. The second prediction model is a prediction model that calculates a predicted value y^{˜} of an output variable y from the value of the input variable x.

More specifically, the first prediction model in the present embodiment is a prediction model that receives k pieces of data in the neighborhood of an input value to be predicted (neighborhood data) as inputs, and outputs parameters of the second prediction model. The second prediction model is a prediction model to which the parameters calculated by the first prediction model are applied, and which receives the input value and the k pieces of neighborhood data as inputs and calculates a predicted value of an output value for the input value. The neighborhood data is k pieces of data in which the value of an input variable is close to the input value in actual result data in which an input variable and an output variable form a pair. k is a natural number that can be set arbitrarily.

When k=1, the first prediction model and the second prediction model can be expressed as Formula (1) and Formula (2), respectively. k=1 is an example and the present embodiment is not limited thereto. k may be arbitrarily set by the administrator from the management terminal 12, and may be 2 or more.

$$\begin{matrix}[ Math . 1 ] & \\ {θ}_{g} = f ( {N}_{1}^{x} ( x ) ; {θ}_{f} ) & ( 1 )\end{matrix}$$

$${y}^{∼} = g ( x , {N}_{1}^{x} ( x ) ; {θ}_{g} ) = A ( x - {N}_{1}^{x} ( x ) ) + B \qquad ( 2 )$$

$${N}_{k}^{x} ( x ) : Input of x in neighborhood of k$$

x is an input variable. y is an output variable. y^{˜} is a predicted value of the output variable for the input value x. f is a function representing the first prediction model. g is a function representing the second prediction model. θ_{f} is a parameter of the first prediction model. N^{x}ₖ(x) is an input of x in the neighborhood of k. In Formula (1) and Formula (2), k=1 is set. θ_{g} is a parameter of the second prediction model. As an example, the first prediction model may be a neural network, and the second prediction model may be a linear regression model. A and B are a slope and an intercept of a regression line when the second prediction model is a linear regression model, and are parameters of the second prediction model. However, the model structures of the first prediction model and the second prediction model are not limited to the present example.

Returning back to FIG. 3, in step 102, the prediction execution unit 22 executes prediction processing.

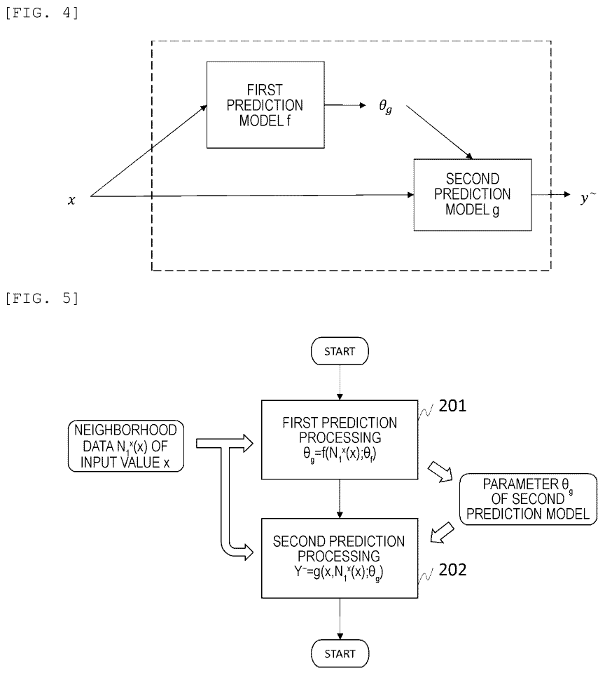

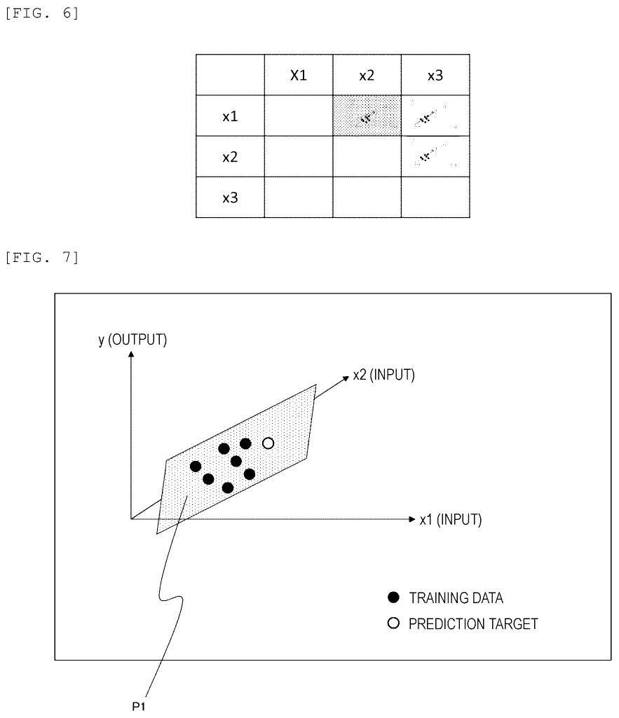

FIG. 5 is a flowchart of the prediction processing in the first embodiment.

In step 201, the prediction execution unit calculates parameters of the second prediction model by inputting the neighborhood data of the input value x to be predicted to the first prediction model. Next, in step 202, the prediction execution unit 22 applies the parameters calculated by the first prediction model to the second prediction model, inputs the input value x and the neighborhood data to the second prediction model, and acquires a predicted value of the output variable calculated by the second prediction model.

Prediction results of the prediction execution unit 22 are converted into control commands by the planning unit 26 and applied to the controlled devices 13 and 14. The collection unit 25 acquires pairs of output values and input values applied to the controlled devices 13 and 14 as actual result data.

As described above, when the prediction execution unit 22 performs prediction in step 102, the learning processing performed by the model management unit 21 in step 101 is terminated, and the learning processing is not included in the prediction processing. Thus, in the present embodiment, it is not necessary to generate a prediction model each time prediction is performed.

Next, in step 103, the model management unit 21 updates the parameters of the first prediction model based on the training data used to generate the first prediction model and the second prediction model. Here, the model management unit 21 updates the parameters of the first prediction model by, for example, a back propagation method.

More specifically, as an example, the model management unit 21 focuses on a certain piece of training data included in the accumulated training data, sets other k pieces of training data in the neighborhood of the certain piece of training data as neighborhood data, calculates the value of the output variable from the value of the input variable of the neighborhood data by using the first prediction model and the second prediction model, and updates the parameters of the first prediction model to minimize an error (objective function) between the calculated and obtained value of the output variable and the value of the output variable of the neighborhood data. The objective function can be expressed as E in Formula (3). In Formula (3), the focused training data is (xᵢ, yᵢ), and the neighborhood data thereof is (N^{x}ₖ(xᵢ), N^{y}ₖ(yᵢ)).

$$\begin{matrix}[ Math . 2 ] & \\ E = \sqrt{\sum i \sum {k ( g ( {N}_{k}^{x} ( {x}_{i} ) , {x}_{i} ; {θ}_{g} ) - {N}_{k}^{y} ( {x}_{i} ) )}^{2}} & ( 3 )\end{matrix}$$

$${N}_{k}^{x} ( {x}_{i} )$$

### Input of xᵢ in Neighborhood of k

$${N}_{k}^{y} ( {x}_{i} )$$

### Output of xᵢ in Neighborhood of k

$${θ}_{g} = f ( {x}_{i} ; {θ}_{f} )$$

In the present embodiment, as shown in Formula (3), the objective function is configured based on mean squared error (MSE), but the invention is not limited thereto. As another example, the objective function may be configured by another method such as mean absolute error (MAE) or hinge loss error. In addition, here, an example in which k pieces of neighborhood data are extracted from the training data and used for the objective function is described, but the invention is not limited thereto. As another example, instead of extracting neighborhood data from training data, the closer the data is to the focused training data, the greater the weighting of the data may be given to other pieces of training data, and the weighted data may be used to calculate an error (objective function).

Further, in the present embodiment, the model management unit 21 may update the parameters of the first prediction model to minimize an objective function in which regularization terms or constraint conditions for the parameters of the second prediction model (for example, a constraint in which a slope is positive in the case of a linear regression model) are added to the above-mentioned error.

The prediction system 20 of the present embodiment provides various user interfaces to the administrator. The interface management unit 23 may display a three-dimensional response surface formed by two input variables and one output variable for the selected second prediction model. For example, two input variables that contribute highly to the second prediction model may be selected by an attention mechanism. Alternatively, the administrator may arbitrarily select two input variables for the second prediction model. In addition, plots of a prediction target and neighborhood data may be displayed together with the response surface.

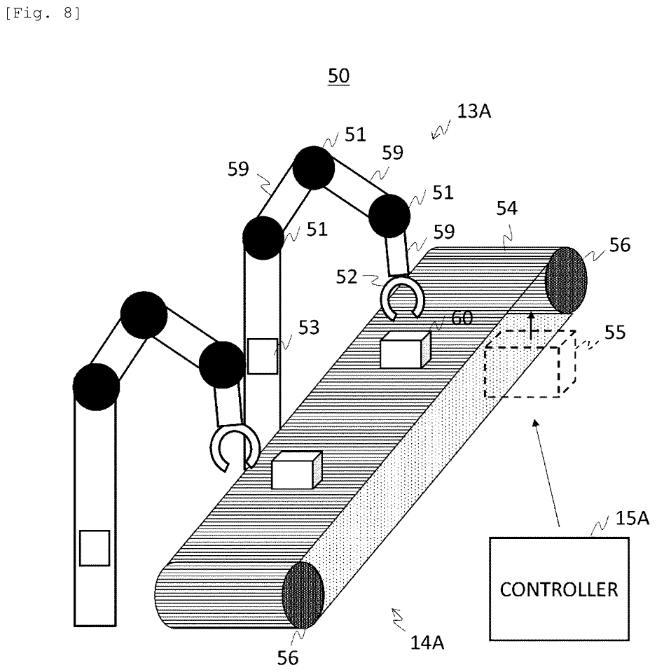

FIG. 6 is a conceptual diagram showing a state where two input variables for the second prediction model are selected. FIG. 7 is a diagram showing a state where the response surface is displayed.

In the example of FIG. 6, the second prediction model has three input variables of x1, x2, and x3. A hatched cell in FIG. 6 shows a region representing the two selected input variables. In the example of FIG. 6, two input variables of x1 and x2 are selected from among the three input variables. Referring to FIG. 7, a response surface P1 of a local linear regression model is shown in a three-dimensional space with the two selected input variables x1 and x2 and one output variable y as three axes. In addition, a prediction target and training data in the neighborhood thereof are shown by plots.

Further, in the present embodiment, an example in which the controlled devices 13 and 14 are a robot arm device and a line conveyance device disposed on the site of a manufacturing line or a logistics warehouse is described, but the invention is not limited thereto. As another example, a rolling device that rolls processed workpieces while conveying the workpieces with a conveyance device to manufacture metal plates having a uniform shape may be used as the controlled devices 13 and 14, and shape control may be realized by the control device 11. In addition, various devices such as a power system stabilizer (PSS) in a power supply system and an automatic physical property searching robot in materials informatics can be used as the controlled devices 13 and 14.

As described above, according to the present embodiment, for example, in a system that moves articles between work areas by a belt conveyor and performs work on the articles by a robot arm in the work area, it is possible to appropriately control the operations of the belt conveyor and the robot arm and efficiently perform work to maintain a throughput without placing a large number of articles in a buffer immediately before the work area. Thereby, it is possible to reduce a physical region of the buffer immediately before the work area.

Hereinafter, some more specific examples of the first embodiment will be described.

### (1) First Example

In a first example, a configuration that realizes control on the site where work is performed on articles, which are conveyed by a belt conveyor, by a robot arm is exemplified. The control system 10 in the above-described embodiment controls a robot arm including a controller and a belt conveyor controlled via an external controller 15. The work performed by the robot arm includes conveyance, palletizing, assembling, painting, and the like of parts in the manufacture of products. More specifically, the work includes soldering electronic parts to substrates of in-vehicle devices and assembling the in-vehicle devices. The belt conveyor conveys parts, semi-finished products, and products, and the robot arm palletizes the parts conveyed by the belt conveyor, performs soldering of the parts or painting (printing) on the semi-finished products, and assembles the products.

In the present example, the control device 11 imparts tip coordinates and a gripping state to the robot arm as control commands, the controller in the robot arm performs trajectory planning of the robot arm, the control device 11 corrects the trajectory planning and imparts the corrected trajectory planning to the robot arm, and the controller of the robot arm performs PID control of joint angles and the like. In the present example, objects to be gripped and moved by the robot arm include articles that are heavy enough to affect the operation of the robot arm. When the weight of an object gripped by a single robot arm is large, the robot arm will not operate according to ideal trajectory planning due to displacement caused by the weight and a delay in operation caused by a moment. In the present example, a force sensor is provided in the robot arm, and the trajectory planning is corrected using a prediction model based on force information acquired by the force sensor.

The prediction model is constructed to receive final target states of tip coordinates and a gripping state of the robot arm, results of a trajectory planning performed by the controller of the robot arm, tip coordinates and a gripping state which are measured as the actual results of the robot arm, and a state measured as the actual result of the belt conveyor that conveys articles for which the robot arm performs work as inputs, and to output the next tip coordinates and gripping state of the robot arm as prediction results. The control device 11 corrects the trajectory planning performed by the controller of the robot arm based on prediction results obtained by the prediction model, and generates control commands for the robot arm according to the corrected trajectory planning. The prediction model is configured by a first prediction model and a second prediction model, where the first prediction model is a neural network and the second prediction model is a linear regression equation.

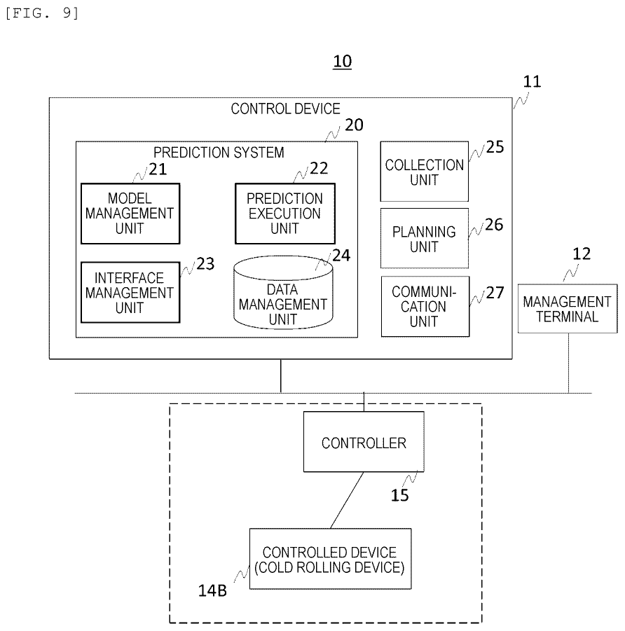

FIG. 8 is a conceptual diagram showing an on-site system according to the first example. An on-site system 50 includes a robot arm 13A, a belt conveyor 14A, and a controller 15A.

The robot arm 13A includes links 59, joints 51, a gripper 52, and a controller 53. The links 59 are connected to each other by the joints 51 so that an angle can be freely changed. The gripper 52 is connected to the tip of the robot arm 13A. As an example, the gripper 52 includes two claws that open and close by changing a relative angle from the fulcrum, and performs gripping and non-gripping by opening and closing the claws. The joints 51 and the gripper 52 are provided with an actuator driven by a servo motor.

The robot arm 13A can take a desired posture by changing the angle of the joint 51 with the actuator. The servo motor includes a sensor which sequentially measures an angle and a torque, and measurement results are input to the controller 53.

The gripper 52 performs a gripping operation by changing an angle with the actuator. The servo motor of the gripper 52 includes a sensor which sequentially measures an angle and a torque. In addition, a force sensor is attached between the link 59 on the tip side and the gripper 52. The force sensor sequentially measures force information including a reaction force and a moment. The measurement results of the angle, the torque, and the force information are input to the controller 53.

The control device 11 transmits tip coordinates and a gripping state of the robot arm 13A to the controller 53 as control commands. The tip coordinates are coordinates indicating a position to which the gripper 52 disposed at the tip of the robot arm 13A is moved. The gripping state indicates the state of the gripper 52, and there are two states, that is, a gripping state where an article 60 is gripped, and a non-gripping state where nothing is gripped.

The controller 53 receives inputs of the tip coordinates and the gripping state as control commands from the control device 11, receives inputs of the angle and the torque which are measurement results from the sensor of the servo motor of the joint 51, receives inputs of the angle and the torque which are measurement results from the sensor of the gripper 52, and receives inputs of the reaction force and the moment which are measurement results from the force sensor of the gripper 52.

The controller 53 performs inverse kinematic calculation and trajectory planning based on the tip coordinates of the control command, and determines a time transition of the angle of each joint 51 for moving the tip of the robot arm 13A from the current position to the position indicated in the control command. An algorithm of the trajectory planning is not particularly limited. For example, it is preferable to determine a time transition of the angle of each joint 51 so that the tip of the robot arm 13A moves on a smooth trajectory. The controller 53 controls the angle of each joint 51 by PID control based on the determined time transition of the angle of each joint 51 and the measurement results of the angle and the torque which are measured by the sensor of each joint 51. Specifically, the controller 53 controls, for example, a voltage and a current applied to the servo motor that drives the actuator of each joint 51.

Furthermore, the controller 53 transmits the actual tip coordinates, gripping state, and force sense information which are measured as the results of the above-mentioned control to the control device 11.

On the other hand, the tip coordinates, gripping state, and force sense information which are control results are input from the controller 53 to the control device 11 as actual result data. In the control device 11, the collection unit 25 collects the actual result data from the controller 53 and transmits the actual result data to the prediction system 20. The actual result data becomes a part of the input variables x for the first prediction model and the second prediction model in the prediction execution unit 22.

In addition, the actual result data, that is, the tip coordinates and the gripping state, are accumulated by the data management unit 24. The collection unit 25 creates training data based on the accumulated actual result data. The training data can be created by combining various types of information input to the prediction model at a certain time t and the prediction results output from the prediction model with the actual result data acquired at the next time t+1. When learning is performed, the prediction model may be preferably updated to minimize an error between the prediction result and the actual result data according to the objective function described above.

In the control device 11, the model management unit 21 constructs a first prediction model for the robot arm and a second prediction model for the robot arm by learning the training data, and also updates the first prediction model for the robot arm.

The input variables x for the first prediction model for the robot arm and the second prediction model for the robot arm include the final target states of the tip coordinates and the gripping state of the robot arm 13A, the results of the trajectory planning performed by the controller 53 of the robot arm 13A, the actual result data of the robot arm 13A which is given from the controller 53 via the collection unit 25, and the actual result data of the belt conveyor 14A which is given from the controller 15A. The control commands for the robot arm 13A include the planned tip coordinates and gripping state of the robot arm 13A. The actual result data of the robot arm 13A includes the actual tip coordinates, gripping state, and force sense information of the robot arm 13A. The actual result data of the belt conveyor 14A includes a rotation speed as a control result of the belt conveyor 14A.

An output y^{˜} of the second prediction model for the robot arm is a prediction result of the next tip coordinates and gripping state of the robot arm 13A. It is possible to predict the tip coordinates and gripping state considering the weight of a gripped object by using the second prediction model for the robot arm. The planning unit 26 creates corrected trajectory planning using a plurality of prediction calculations using the second prediction model for the robot arm, and generates control commands to be given to the robot arm 13A based on the corrected trajectory planning. A specific example of the processing for generating control commands by repeatedly using a plurality of prediction calculations will be described later.

On the other hand, the belt conveyor 14A includes a belt 54, a motor 55, and a pulley 56 and is a device that linearly transports an article 60 placed on the belt 54 by the motor 55 rotating the pulley 56 around which the annular belt 54 is wound. The belt conveyor 14A can control the speed at which the article 60 on the belt 54 is moved by the rotation speed of the motor 55.

The control device 11 imparts the rotation speed of the motor 55 to the controller 15A as a control command. The rotation speed is the number of times of rotation per unit time, for example, the number of times of rotation per minute. The controller 15A calculates the values of a voltage and a current to be applied to the motor 55 for controlling the motor 55 to the rotation speed imparted in response to the control command by PID control, and imparts the calculated values to the motor 55 as an operation amount.

The belt conveyor 14A includes an encoder. The encoder measures the actual rotation speed of the motor 55. The rotation speed measured by the encoder is output to the controller 15A and used for PID control, and is also transmitted from the controller 15A to the control device 11 as the actual result data.

The controller 15A controls the speed of the belt of the belt conveyor 14A or the rotation speed of the motor by PID control based on a target motor rotation speed indicated in the imparted control command and the motor rotation speed measured by the encoder of the belt conveyor 14A. Specifically, the controller 15A controls, for example, a voltage and a current to be applied to the motor 55.

The control device 11 receives an input of the rotation speed as the control result from the controller 15A as actual result data. In the control device 11, the collection unit 25 collects the actual result data from the controller 15A and transmits the collected data to the prediction system 20. The actual result data becomes a part of the input variables x for the first prediction model and the second prediction model in the prediction execution unit 22.

In addition, the actual result data, that is, the rotation speed, is accumulated by the data management unit 24. The collection unit 25 creates training data by adding label information input from the management terminal 12 to the accumulated actual result data.

In the control device 11, the model management unit 21 constructs and updates a first prediction model for the belt conveyor and a second prediction model for the belt conveyor by learning the training data.

The input variables x for the first prediction model for the belt conveyor and the second prediction model for the belt conveyor include the control command for the belt conveyor 14A imparted from the planning unit 26, the actual result data of the belt conveyor 14A imparted from the controller 3 via the collection unit 25, and the actual result data of the robot arm 13A imparted from the controller 53 of the robot arm 13A. The control command for the belt conveyor 14A imparted from the planning unit 26 includes a planned rotation speed of the motor 55 of the belt conveyor 14A which is imparted from the planning unit 26. The actual result data of the belt conveyor 14A includes the actual rotation speed of the motor 55 of the belt conveyor 14A. The actual result data of the robot arm 13A includes tip coordinates and a gripping state.

An output y^{˜} of the second prediction model for the belt conveyor is a control command imparted to the controller 15A. The control command imparted to the controller 15A is a control command in which the actual result data is reflected to the planned control command imparted from the planning unit 26, and for example, the belt speed or the rotation speed of the motor 55 is designated. The belt speed corresponds to the rotation speed of the motor of the belt conveyor.

Here, an example of processing in which the planning unit 26 mentioned above generates best control commands by repeatedly using prediction calculations of the prediction system 20 a plurality of times for the robot arm 13A is described below.

First, the planning unit 26 calculates an optimal solution of a tip position for each robot arm and executes trajectory planning. Next, the planning unit 26 confirms will whether interference occur based on trajectory information of each arm which is obtained by the trajectory planning. The interference mentioned here includes not only interference of the gripper 52 at the tip but also interference of the link 59. When interference will not occur, the planning unit 26 adopts the current solution. When interference will occur, the planning unit 26 executes trajectory planning again to make fine adjustment. The fine adjustment will be described below.

As an example, in the fine correction, when the current trajectory planning indicates that two arms are likely to interfere with each other, the planning unit 26 may perform trajectory planning again for a combination of the two interfering arms and search for a trajectory that will not cause interference. Here, although trajectory planning is executed again for the combination of the two interfering arms, other processing is also possible. For example, trajectory planning may also be executed again for a controlled device in a range specified to include the combination of the two interfering arms. Here, the range in which the trajectory planning is executed again may include not only the arms but also belt conveyors. Although interference between arms are described here, interference between an arm and a belt conveyor can also be avoided through similar processing. As another example, the planning unit 26 may execute trajectory planning again for each of two arms that will cause interference in the current trajectory planning. When the trajectory planning is accompanied by random searching, a trajectory different from the previous trajectory can be obtained in the current trajectory planning. It is confirmed whether interference will occur based on the arm trajectory information obtained in the current trajectory planning, and when interference will occur, trajectory planning is further executed. The processing may be repeated until interference will not occur.

In the fine correction described above, instead of or in combination with the above-mentioned method of executing trajectory planning again, for example, the operation of one of the interfering robot arms may be made to wait until the operation of the other robot arm proceeds. The planning unit 26 divides a predetermined unit time into a predetermined number of blocks based on trajectory information of each robot arm, proceeds with the operation of the robot arms in units of blocks, and confirms whether interference occurs. When interference occurs, the operation of one robot arm in the block may be made to wait until the operation of the other robot arm in the block ends.

In the present example, as such, it is possible to perform complex control for appropriately coordinating a plurality of robots.

Although a belt conveyor that linearly conveys articles is exemplified above in the present example, the invention is not limited thereto. As another example, the control device 11 can similarly control even an xyz table that can move articles in a three-dimensional space.

Further, in the present example, an example in which the controller 15A transmits the actual result data on the rotation speed of the motor 55 to the control device 11 is described, but the invention is not limited thereto. As another example, the controller 15A may calculate the state of the belt conveyor 14A based on the rotation speed measured by the encoder of the belt conveyor 14A, and transmit information on the state to the control device 11. The form of the state of the belt conveyor 14A is not particularly limited, but the state may be indicated, for example, by the speed of the belt.

Further, in the present example, a robot arm equipped with a gripper that opens and closes two claws to grip an article is exemplified, but the robot arm may be equipped with a gripper that adsorbs an article by a suction mechanism as another example.

Further, in the present example, an example in which a prediction model for the robot arm and a prediction model for the belt conveyor are constructed separately is described, but the invention is not limited to such configuration. The control of the robot arm 13A and the belt conveyor 14A may be realized by a single prediction model. For example, in an application in which the robot arm 13A and the belt conveyor 14A realize work for an article 60 in association with each other, it may be preferable to realize the control of the robot arm and the belt conveyor by a single prediction model.

According to the first example described above, it is possible to suitably control work for articles while reducing interference with the robot arm. In addition, currently, robot arms and belt conveyors provided by various companies have application programming interfaces (APIs) with specifications unique to each company or product. Therefore, it is difficult to implement simulations and control such as interference checks for transversely handling a plurality of products. Specifically, the reality is that it may be difficult or costly to run physical simulators for a plurality of robots with an existing trajectory planning engine due to differences in APIs. On the other hand, when an integrated control system that unifies simulators in the form of a prediction model is separately constructed as in the present example without using a unique API of each company and product, it is possible to transversely implement simulations and control for a plurality of products.

### (2) Second Example

In a second example, a configuration for realizing the control of a site where cold rolling is performed is exemplified. The control system 10 according to the above-described embodiment controls a cold rolling device.

In the present example, data on time-series operations performed manually by human on the cold rolling device is accumulated, and the control device 11 automates the control of the cold rolling device based on the accumulated data.

A prediction model is constructed to receive the shape of a target plate, the shape of a to-be-rolled material that is fed into the cold rolling device, the current state of the cold rolling device, and the next operation to be performed as inputs, and to output the next state of the device and the shape of the plate as prediction results. The prediction model is configured by a first prediction model and a second prediction model, where the first prediction model is a neural network and the second prediction model is a linear regression equation.

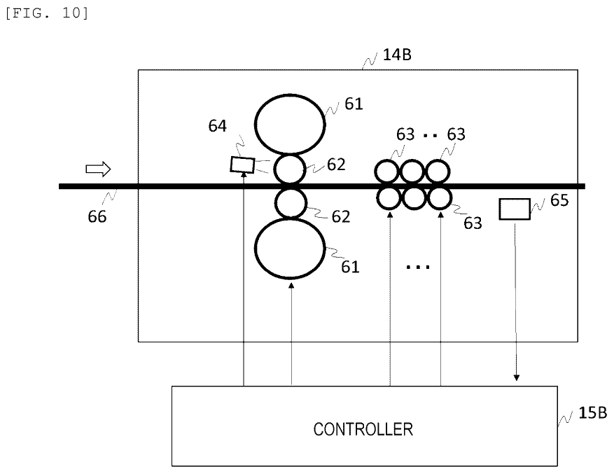

FIG. 9 is a block diagram of a control system according to the second example. The control system according to the second example shown in FIG. 9 differs from the control system shown in FIG. 1 in that there is no controlled device that includes a controller. In the second example, a cold rolling device 14B is a controlled device on the site.

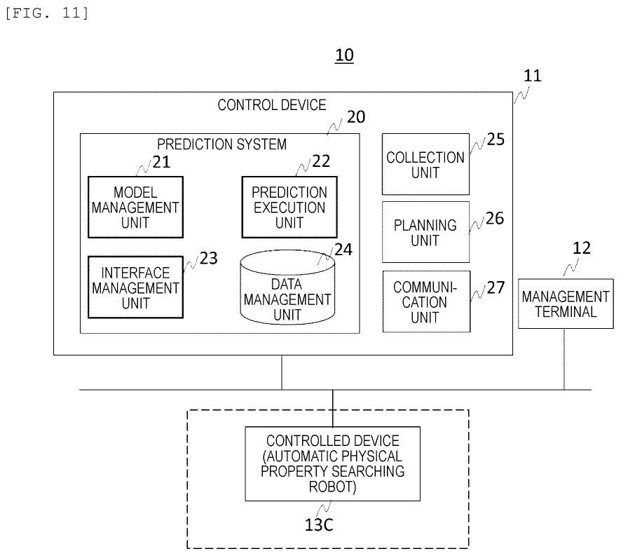

FIG. 10 is a simplified conceptual diagram of the cold rolling device. The cold rolling device 14B includes backup rolls 61, work rolls 62, leveling rolls 63, a coolant injector 64, and a shape meter 65. A plurality of pairs of leveling rolls 63 are disposed side by side in a moving direction of a to-be-rolled material 66, as indicated by an arrow in the drawing, and in a plate width direction perpendicular to the moving direction, and a leveling position can be designated for each of the leveling rolls 63. A plurality of coolant injectors 64 are disposed in the plate width direction, and the amount of coolant injected can be designated for each of the coolant injectors 64.

In the cold rolling device 14B, the to-be-rolled material 66 passes through a gap between a pair of work rolls 62 which is set to a desired roll gap via abutting backup rolls 61, and the to-be-rolled material 66 is leveled by the plurality of leveling rolls 63 to generate a plate having a desired shape. The shape of the plate means the degree of curvature of the plate. Meanwhile, an appropriate amount of coolant is injected to appropriate positions of the work rolls 62 from the coolant injector 64 at an appropriate timing. The shape meter 65 measures the shape of the processed plate. The shape meter 65 is configured by a plurality of distance measuring devices arranged in the plate width direction. In the cold rolling device 14B, control is performed by using the shape of the plate as a control amount and using the rotation speed of the work rollers 62, the leveling positions of the leveling rollers 63, and the amount of coolant injected as operation amounts.

The control device 11 transmits the rotation speed of the work rollers 62, the leveling positions of the leveling rollers 63, and the amount of coolant injected to a controller 15B as control commands.

The controller 15B inputs the control commands received from the control device 11 to each part of the cold rolling device 14A.

In addition, the shape of the plate measured by the shape meter 65 is input to the controller 15B as the actual result data, and the actual result data is transmitted from the controller 15B to the control device 11. In the control device 11, the collection unit 25 acquires actual result data and transmits the acquired data to the prediction system 20. The actual result data becomes a part of input variables x for the first prediction model and the second prediction model in the prediction execution unit 22.

In addition, the actual result data is accumulated by the data management unit 24. The collection unit 25 then creates training data by adding label information to the accumulated actual result data. The label added to the actual result data is, for example, a difference between a target shape of the plate and the actual shape.

In the control device 11, the model management unit 21 constructs a first prediction model and a second prediction model by learning the training data, and also updates the first prediction model.

The input variables x for the first prediction model and the second prediction model include a target plate shape imparted by the planning unit 26, the actual result data imparted by the controller 15B via the collection unit 25, the current state of the device, and an operation amount of an operation to be performed next. The current state of the device includes the rotation speed of the work rollers 62, the leveling positions of the leveling rollers 63, and the amount of coolant injected by the coolant injector 64. The amount of operation to be performed next also includes the rotation speed of the work rollers 62, the leveling positions of the leveling rollers 63, and the amount of coolant injected by the coolant injector 64.

An output y″ of the second prediction model is a control command to be imparted to the cold rolling device 14B. The control command to be imparted to the controller 53 also includes, as the amount of the operation to be performed next, the rotation speed of the work rollers 62, the leveling positions of the leveling rollers 63, and the amount of coolant to be injected by the coolant injector 64.

The planning unit 26 selects an operation capable of bringing the shape of the plate closest to the target shape as the operation to be performed next, and sets the amount of the operation as a control command for the controller 15B.

According to the second example described above, it is possible to manufacture a plate with high accuracy by suitably controlling the shape of the plate.

### (3) Third Example

In a third example, a configuration is exemplified that realizes the control of an automatic physical property searching robot that measures physical properties of a product obtained by blending a plurality of materials using a robot that weighs the materials and puts the materials into a mixing container, and searches for a blend for obtaining a product with desired physical properties. The automatic physical property searching robot is, for example, a robot that produces chemicals, medicines, food, and oil. A preferable example of chemicals is plastic produced by mixing polymers, resins, and additives. In the example of plastics, physical properties that are measured include a gloss, fluidity, bending stiffness, breaking elongation, a softening temperature, and the like.

In the present example, data indicating a relationship between past blending of materials and physical properties of products obtained by the past blending is accumulated, and the control device 11 realizes the control the automatic physical property searching robot based on the accumulated data.

A prediction model is constructed to receive the blending of materials as inputs, and to output physical properties of products obtained by the blending as prediction results. The prediction model is configured by a first prediction model and a second prediction model, where the first prediction model is a neural network and the second prediction model is a linear regression equation.

FIG. 11 is a block diagram of a control system according to the third example. The control system according to the third example shown in FIG. 11 differs from the control system shown in FIG. 1 in that there is no controlled device that does not include a controller. In the third example, an automatic physical property searching robot 13C is a controlled device on the site.

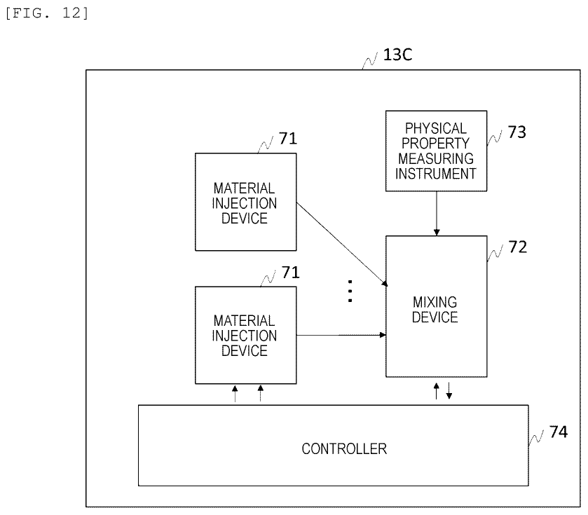

FIG. 12 is a simplified block diagram of the automatic physical property searching robot. The automatic property searching robot 13C includes a plurality of material injection devices 71, a mixing device 72, a physical property measuring instrument 73, and a controller 74. The material injection device 71 is a device that injects a designated amount of designated material into a container. The mixing device 72 is a device that mixes a plurality of materials injected by the plurality of material injection devices 71 in the container to generate a product. The physical property measuring instrument 73 is a measuring instrument that measures the physical properties of the product generated in the container. The controller 74 controls the material injection devices 71 and the mixing device 72 in response to control commands received from the control device 11 to generate a product, and notifies the control device 11 of the physical properties of the product measured by the physical property measuring instrument 73 as actual result data.

The control device 11 transmits the blending of materials to the controller 74 as a control command.

The controller 74 inputs the control command received from the control device 11 to each unit.

The controller 74 also receives an input of the physical properties of the product measured by the physical property measuring device 73 as the actual result data, and transmits the actual result data to the control device 11. In the control device 11, the collection unit 25 acquires the actual result data and transmits the acquired data to the prediction system 20.

The actual result data is accumulated by the data management unit 24. The collection unit 25 then creates training data by adding label information to the accumulated actual result data. The label added to the actual result data is, for example, a difference between target physical properties of the product and the actual physical properties.

In the control device 11, the model management unit 21 constructs a first prediction model and a second prediction model by learning the training data, and also updates the first prediction model.

Input variables x for the first and second prediction models include blending of materials to be injected.

An output y^{˜} of the second prediction model is physical properties of a product to be generated. A control command imparted to the controller 74 includes blending of materials predicted to generate a product with physical properties closest to target physical properties.

The planning unit 26 selects an operation capable of mixing with blending of materials predicted to generate a product with physical properties closest to the target physical properties as an operation to be performed next, and sets an amount of the operation as a control command for the controller 74.

According to the third example described above, it is possible to generate a product with desired physical properties by suitably blending materials.

### Second Embodiment

In the first embodiment, the control system that constructs the first prediction model and the second prediction model as independent prediction models is exemplified, but other aspects are also possible. In a second embodiment, an example in which the first prediction model and the second prediction model in the first embodiment are constructed integrally is shown as indicated by a dashed line in FIG. 4.

A basic configuration of a control system according to the second embodiment is the same as that in the first embodiment shown in FIG. 1. A hardware configuration of a control device 11 in the second embodiment is the same as that in the first embodiment shown in FIG. 2. The overall processing executed by a prediction system 20 in the second embodiment is basically the same as that in the first embodiment shown in FIG. 3, but there are differences in details.

Differences between the second embodiment and the first embodiment will be described below.

In step 101, the model management unit 21 executes learning processing and constructs a prediction model in which a first prediction model and a second prediction model are integrated. The first prediction model and the second prediction model included therein are basically the same as those in the first embodiment. However, the integrated prediction model in the present embodiment is expressed as a differentiable function.

In step 102, prediction processing executed by the prediction execution unit 22 is the same as that in the first embodiment.

In step 103, the model management unit 21 updates parameters of the first prediction model and the second prediction model based on training data used to generate the first prediction model and the second prediction model. Here, the model management unit 21 updates the parameters of the first prediction model and the second prediction model by a back propagation method.

### Third Embodiment

In the first embodiment, the first prediction model is a prediction model that receives neighborhood data of an input value to be predicted as an input and calculates parameters of the second prediction model, and the second prediction model is a prediction model to which the parameters calculated by the first prediction model is applied and which receives an input value to be predicted and neighborhood data thereof as inputs and outputs a predicted value of an output variable for the input value. However, the inputs and the outputs of the first and second prediction models are not limited thereto. Other examples are shown in a third embodiment.

A basic configuration of a control system according to the third embodiment is the same as that in the first embodiment shown in FIG. 1. A hardware configuration of a control device 11 in the third embodiment is the same as that in the first embodiment shown in FIG. 2. The overall processing executed by a prediction system 20 in the third embodiment is basically the same as that in the first embodiment shown in FIG. 3, but there are differences in details.

In step 101, the model management unit 21 executes learning processing for learning training data to generate a prediction model. A first prediction model is a prediction model that calculates parameters of a second prediction model based on an input value to be predicted. The first prediction model in the present embodiment is, for example, a linear regression model.

In the third embodiment, unlike the first embodiment, the first prediction model is a prediction model that receives an input value to be predicted as an input and outputs the parameters of the second prediction model. The second prediction model is a prediction model to which the parameters calculated by the first prediction model are applied and which receives an input value to be predicted as an input and outputs a predicted value of an output variable for the input value.

The first and second prediction models according to the third embodiment can be expressed as Formula (4) and Formula (5), respectively.

$$\begin{matrix}[ Math . 3 ] & \\ {θ}_{g} = f ( x ; {θ}_{f} ) & ( 4 )\end{matrix}$$

$${y}^{∼} = g ( x , x ; {θ}_{g} ) = B \qquad ( 5 )$$

x is an input variable. y is an output variable. y^{˜} is a predicted value of the output variable. f is a function representing the first prediction model. g is a function representing the second prediction model. θ_{f} is a parameter of the first prediction model. θ_{g} is a parameter of the second prediction model. B is a constant.

In step 102, the prediction execution unit 22 executes prediction processing.

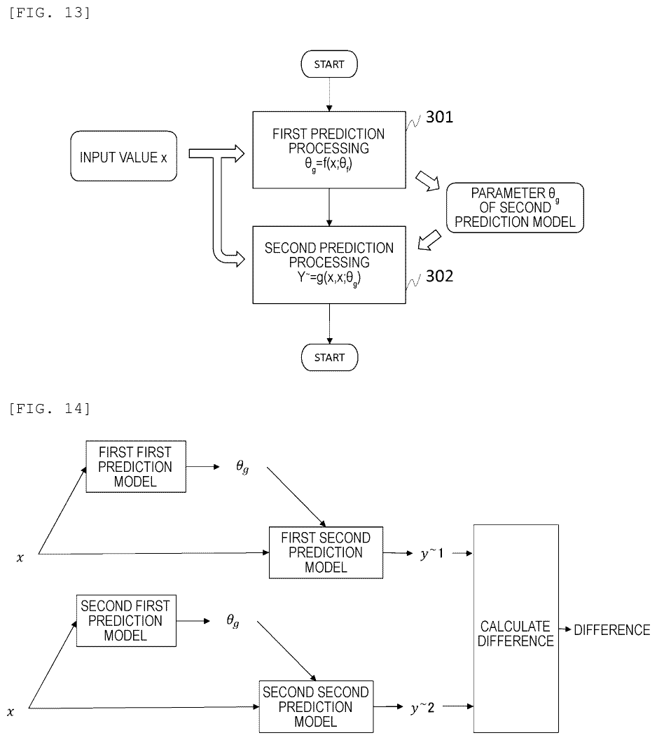

FIG. 13 is a flowchart of the prediction processing in the third embodiment.

In step 301, the prediction execution unit 22 calculates the parameters of the second prediction model by inputting an input value x to be predicted to the first prediction model. Then, in step 302, the prediction execution unit 22 applies the parameters calculated by the first prediction model to the second prediction model, inputs the input value x to the second prediction model, and acquires a predicted value of the output variable calculated by the second prediction model.

The prediction result of the prediction execution unit 22 is converted into a control command by the planning unit 26 and applied to the controlled devices 13 and 14. The collection unit 25 acquires pairs of output values and input values applied to the controlled devices 13 and 14 as actual result data.

Next, in step 103, the model management unit 21 executes update processing to update the parameters of the first prediction model or the parameters of the first prediction model and the second prediction model based on the training data used to generate the first prediction model and the second prediction model. The update processing in the third embodiment is the same as that in the first embodiment.

As described above, the third embodiment differs from the first embodiment in the learning processing for constructing the first prediction model and the second prediction model, and the prediction processing using the first prediction model and the second prediction model. Consequently, as a modification example of the first embodiment or the third embodiment, learning processing and prediction processing may be performed by two methods, and information based on prediction results obtained by the two methods may be presented. FIG. 14 is a conceptual diagram showing prediction models generated by the model management unit in the modification example. In the present modification example, as shown in FIG. 14, the model management unit 21 generates and manages the first prediction model (first first prediction model) and the second prediction model (first second prediction model) used in the first embodiment, and the first prediction model (second first prediction model) and the second prediction model (second second prediction model) used in the third embodiment. The prediction execution unit 22 calculates a predicted value (first predicted value) of an output value for an input value using the first first prediction model and the first second prediction model, and calculates a predicted value (second predicted value) of an output value for an input value using the second first prediction model and the second second prediction model. The interface management unit 23 calculates a difference between the first predicted value and the second predicted value, and displays information based on the difference on the management terminal 12 to present the information to an administrator.

### Fourth Embodiment

In the first embodiment, an example in which a linear regression model is used for the first prediction model and the second prediction model is described, but the invention is not limited thereto. In a fourth embodiment, an example in which a Bayesian estimator based on Bayesian linear regression is used for a second prediction model is described. When the second prediction model in the first embodiment is expressed by Formula (6), a second prediction model in the fourth embodiment can be expressed by Formula (7).

$$\begin{matrix}[ Math . 4 ] & \\ y = {w}^{T} x + ϵ & ( 6 )\end{matrix}$$

$$\begin{matrix}[ Math . 5 ] & \\ p ( X , Y , w ) = p ( Y \vert w , X ) p ( w ) = p ( w ) {\prod }_{n = 1}^{N} p ( {y}_{n} \vert w , {x}_{n} ) & ( 7 )\end{matrix}$$

w is a weight vector, and ε is an error. p is a function that represents a probability distribution, X is a vector of an input variable, Y is a vector of an output variable, and N is the number of pieces of data.

A basic configuration of a control system according to the fourth embodiment is the same as that in the first embodiment shown in FIG. 1. A hardware configuration of a control device 11 in the fourth embodiment is the same as that in the first embodiment shown in FIG. 2. The overall processing performed by a prediction system 20 in the fourth embodiment is basically the same as that in the first embodiment shown in FIG. 3, but there are differences in details.

In learning processing of step 101, the model management unit 21 constructs a second prediction model as a Bayesian linear regression prediction model that calculates a probability distribution of a predicted value of an output variable based on an input value to be predicted, and constructs a first prediction model as a prediction model that calculates a prior distribution of a weight of the second prediction model as a parameter. In prediction processing of step 102, the prediction execution unit 22 performs prediction using the first prediction model and the second prediction model. First, the first prediction model is used to calculate the prior distribution of the weight based on the input value, the prior distribution of the weight is applied to the second prediction model, which is a Bayesian linear regression prediction model, and the second prediction model is used to calculate a probability distribution of an output value. Then, for example, a value with the highest probability may be set as an output value. Here, a risk related to a prediction result can be obtained from the degree of variation in the probability distribution. The risk of the prediction result is also associated with the risk of control for the controlled devices 13 and 14. The interface management unit 23 may present information on the risk to an administrator based on the degree of variation in the probability distribution. In update processing of step 103, the model management unit 21 updates parameters of the first prediction model or parameters of the first and second prediction models based on training data used to generate the first prediction model and the second prediction model.

In the present embodiment, an aspect using Bayesian linear regression is exemplified, but Gaussian process regression can also be used as another aspect.

The first to fourth embodiments described above are examples for describing the present invention, and are not intended to limit the scope of the invention to only the embodiments. Those skilled in the art can implement the present invention in various other aspects without departing from the scope of the present invention.

The first to fourth embodiments also include the following items. However, the items included in the first to fourth embodiments are not limited to those listed below.

### Item 1

A prediction system that predicts an output value, which is a value of an output variable, from an input value, which is a value of an input variable to be predicted, the prediction system including:
a storage device that stores a software program; and
a processor that executes the software program, in which
the processor executes the software program to realize
a model management unit that manages a second prediction model for predicting the output value from the input value and a first prediction model for calculating parameters of the second prediction model based on the input value, and
a prediction execution unit that predicts the output value for the input value by using the second prediction model to which the parameters s calculated by the first prediction model are applied, and
the model management unit uses one or more pieces of training data in the neighborhood of a certain piece of training data included in training data used to generate the first prediction model and the second prediction model as neighborhood data, and updates parameters of the first prediction model to minimize errors occurring in values of output variables calculated by the first prediction model and the second prediction model from values input variables of the neighborhood data.

According to the item, the output value for the input value is calculated using the trained first prediction model and second prediction model, and thus sufficient prediction accuracy can be obtained locally without generating a prediction model each time prediction is performed.

### Item 2

The prediction system according to item 1, in which
the first prediction model is a prediction model that receives the neighborhood data as an input and outputs parameters of the second prediction model, and
the second prediction model is a prediction model to which the parameters calculated by the first prediction model are applied and which receives the input value and the neighborhood data as inputs and outputs a predicted value of the output value for the input value.

According to the item, the neighborhood data of the input value is used as an input for the first prediction model, and thus it is possible to construct the second prediction model capable of locally and appropriately predicting the neighborhood of the input value.

### Item 3

The prediction system according to item 1, in which the model management unit manages a first first prediction model which is a prediction model that receives the neighborhood data as an input and calculates parameters of a first second prediction model, a first second prediction model which is a prediction model to which parameters calculated by the first first prediction model are applied and which receives the input value and the neighborhood data as inputs and outputs a predicted value of the output value for the input value, a second first prediction model which is a prediction model that receives the input value as an input and calculates parameters of a second second prediction model, and the second second prediction model which is a prediction model to which the parameters calculated by the second first prediction model are applied and which receives the input value as an input and outputs a predicted value of the output value for the input value,
the prediction execution unit calculates a first predicted value of the output value for the input value by using the first first prediction model and the first second prediction model, and calculates a second predicted value of the output value for the input value by using the second first prediction model and the second second prediction model, and
an interface management unit that calculates a difference between the first predicted value and the second predicted value and presents information based on the difference is further realized.

According to the item, information based on the difference between the prediction results obtained by the two methods is presented, and thus it is possible to obtain information on the degree to which the prediction results are reliable.

### Item 4

The prediction system according to item 2, in which the model management unit updates the parameters of the first prediction model to minimize a difference between the value of the output variable obtained from a value of an input variable of the neighborhood data by using the first prediction model and the second prediction model and the value of the output variable in the neighborhood data.

### Item 5

The prediction system according to item 4, in which the model management unit updates the parameters of the parameters of the first prediction model and the parameters of the second prediction model to minimize the difference.

### Item 6

The prediction system according to item 4, in which the model management unit updates the parameters of the first prediction model to minimize an amount obtained by adding a regularization term for the parameters of the second prediction model to the difference.

According to the item, overlearning can be suppressed by regularization when updating the parameters.

### Item 7

The prediction system according to item 1, in which the processor executes the software program to further realize an interface management unit t that generates information for displaying a three-dimensional response surface formed by two input variables and one output variable of the second prediction model which are selected by an attention mechanism.

### Item 8

The prediction system according to item 2, in which
the first prediction model and the second prediction model are integrally expressed as a differentiable function, and
the model management unit updates parameters of the first prediction model by a back propagation method.

According to the item, the first prediction model and the second prediction model can be trained together as a whole, making it easy to update the parameters.

### Item 9

The prediction system according to item 1, in which
the first prediction model is a prediction model that receives the input value as an input and outputs the parameters of the second prediction model, and
the second prediction model is a prediction model to which the parameters calculated by the first prediction model are applied and which receives the input value as an input and outputs a predicted value of the output value for the input value.

### Item 10

The prediction system according to item 1, in which
the second prediction model is a prediction model that calculates a probability distribution of the output value from the input value by Bayesian estimation, and
the first prediction model is a prediction model that predicts a parameter of a prior distribution of a weight of the second prediction model.

According to the item, a predicted value can be obtained by Bayesian estimation.

### Item 11

The prediction system according to item 10, in which the processor executes the software program to realize an interface management unit that presents information based on a probability distribution of an output variable predicted using the first prediction model and the second prediction model.

According to the item, it is possible to know risks related to prediction accuracy.

### REFERENCE SIGNS LIST

11: control device
12: management terminal
13: controlled device
14: controlled device
15: controller
20: prediction system
21: model management unit
22: prediction execution unit
23: interface management unit
24: data management unit
25: collection unit
26: planning unit
27: communication unit
31: processor
32: main memory
33: storage device
34: communication device
35: bus

1. A prediction system that predicts an output value, which is a value of an output variable, from an input value, which is a value of an input variable to be predicted, the prediction system comprising:
a storage device that stores a software program; and
a processor that executes the software program, wherein
the processor executes the software program to realize
a model management unit that manages a second prediction model for predicting the output value from the input value and a first prediction model for calculating parameters of the second prediction model based on the input value, and
a prediction execution unit that predicts the output value for the input value by using the second prediction model to which the parameters calculated by the first prediction model are applied, and
the model management unit uses one or more pieces of training data in the neighborhood of a certain piece of training data included in training data used to generate the first prediction model and the second prediction model as neighborhood data, and updates parameters of the first prediction model to reduce errors occurring in values of output variables calculated by the first prediction model and the second prediction model from values of input variables of the neighborhood data.

2. The prediction system according to claim 1, wherein
the first prediction model is a prediction model that receives the neighborhood data as an input and outputs parameters of the second prediction model, and
the second prediction model is a prediction model to which the parameters calculated by the first prediction model are applied and which receives the input value and the neighborhood data as inputs and outputs a predicted value of the output value for the input value.

3. The prediction system according to claim 1, wherein
the model management unit manages a first first prediction model which is a prediction model that receives the neighborhood data as an input and calculates parameters of a first second prediction model, a first second prediction model which is a prediction model to which parameters calculated by the first first prediction model are applied and which receives the input value and the neighborhood data as inputs and outputs a predicted value of the output value for the input value, a second first prediction model which is a prediction model that receives the input value as an input and calculates parameters of a second second prediction model, and the second second prediction model which is a prediction model to which the parameters calculated by the second first prediction model are applied and which receives the input value as an input and outputs a predicted value of the output value for the input value,
the prediction execution unit calculates a first predicted value of the output value for the input value by using the first first prediction model and the first second prediction model, and calculates a second predicted value of the output value for the input value by using the second first prediction model and the second second prediction model, and
an interface management unit that calculates a difference between the first predicted value and the second predicted value and presents information based on the difference is further realized.

4. The prediction system according to claim 2, wherein the model management unit updates the parameters of the first prediction model to reduce a difference between the value of the output variable obtained from a value of an input variable of the neighborhood data by using the first prediction model and the second prediction model and the value of the output variable in the neighborhood data.

5. The prediction system according to claim 4, wherein the model management unit updates the parameters of the first prediction model and the parameters of the second prediction model to reduce the difference.

6. The prediction system according to claim 4, wherein the model management unit updates the parameters of the first prediction model to reduce an objective function obtained by adding a regularization term or a constraint condition for the parameters of the second prediction model to the difference.

7. The prediction system according to claim 1, wherein the processor executes the software program to further realize an interface management unit that generates information for displaying a three-dimensional response surface formed by two input variables and one output variable of the second prediction model which are selected by an attention mechanism.

8. The prediction system according to claim 2, wherein
the first prediction model and the second prediction model are integrally expressed as a differentiable function, and
the model management unit updates parameters of the first prediction model by a back propagation method.

9. The prediction system according to claim 1, wherein
the first prediction model is a prediction model that receives the input value as an input and outputs the parameters of the second prediction model, and
the second prediction model is a prediction model to which the parameters calculated by the first prediction model are applied and which receives the input value as an input and outputs a predicted value of the output value for the input value.

10. The prediction system according to claim 1, wherein
the second prediction model is a prediction model that calculates a probability distribution of the output value from the input value by Bayesian estimation, and
the first prediction model is a prediction model that predicts a parameter of a prior distribution of a weight of the second prediction model.

11. The prediction system according to claim 10, wherein the processor executes the software program to realize an interface management unit that presents information based on a probability distribution of an output variable predicted using the first prediction model and the second prediction model.

12. A control device that controls a controlled device, the control device comprising:
a storage device that stores a software program; and
a processor that executes the software program, wherein
the processor executes the software program to realize
a model management unit that manages a second prediction model for predicting an output value, which is a value of an output variable to be predicted, from an input value, which is a value of an input variable to be predicted, and a first prediction model for calculating parameters of the second prediction model based on the input value, the second prediction model and the first prediction model being constructed by learning actual result data,
a prediction execution unit that calculates a predicted value of the output value for the input value by using the second prediction model to which the parameters calculated by the first prediction model are applied, and
a planning unit that generates a control command for the controlled device based on the predicted value and applies the control command to the controlled device, and
the model management unit uses one or more pieces of training data in the neighborhood of a certain piece of training data included in training data used to generate the first prediction model and the second prediction model as neighborhood data, and updates parameters of the first prediction model to reduce errors occurring in values of output variables calculated by the first prediction model and the second prediction model from values of input variables of the neighborhood data.

13. The control device according to claim 12, wherein the controlled device includes a conveyance device that conveys an article and a work device that performs work on the article conveyed by the conveyance device.

14. A control method for controlling a controlled device, the control method comprising:
causing a processor to execute a software program in a computer including a storage device that stores the software program and the processor that executes the software program, so that the processor
stores a second prediction model for predicting an output value, which is a value of an output variable to be predicted, from an input value, which is a value of an input variable to be predicted, and a first prediction model for calculating parameters of the second prediction model based on the input value, the second prediction model and the first prediction model being constructed by learning actual result data,
calculates a predicted value of the output value for the input value by using the second prediction model to which the parameters calculated by the first prediction model are applied, generates a control command for the controlled device based on the predicted value and applies the control command to the controlled device, and
uses one or more pieces of training data in the neighborhood of a certain piece of training data included in training data used to generate the first prediction model and the second prediction model as neighborhood data, and updates parameters of the first prediction model to reduce errors occurring in values of output variables calculated by the first prediction model and the second prediction model from values of input variables of the neighborhood data.
